(19) United States
(12) Patent Application Publication
(10) Pub. No.: US 2009/0014644 A1
(43) Pub. Date: Jan. 15, 2009

(54) IN-SITU ION SOURCE CLEANING FOR PARTIAL PRESSURE ANALYZERS USED IN PROCESS MONITORING

(75) Inventors: Chenglong Yang, Fremont, CA (US); Jeffrey P. Merrill, San Jose, CA (US); Louis C. Frees, Manlius, NY (US); Steven J. Lakeman, Newbury Park, CA (US)

Correspondence Address: Hiscock & Barclay, LLP, One Park Place, 300 South State Street, Syracuse, NY, 13202-2078, US

(73) Assignee: Inficon, Inc., East Syracuse, NY (US)

(21) Appl. No.: 12/170,810

(22) Filed: Jul. 10, 2008

Related U.S. Application Data
(60) Provisional application No. 60/959,335, filed on Jul. 13, 2007.

(51) Int. Cl. B01D 59/44

(52) U.S. Cl. 250/288

(57) ABSTRACT

An ion source apparatus for partial pressure analyzers and in-situ cleaning method thereof based on inducing a hollow cathode discharge (HCD) inside the ion source. The HCD is formed by applying a high negative voltage to one or more parts of the ion source, including the anode electrode, the lens focus plate and at least one other lens or other form of plate, such as a total pressure collector plate.

### CROSS-REFERENCE TO RELATED APPLICATIONS

This application is based upon a provisional patent application entitled: IN-SITU ION SOURCE CLEANING FOR PARTIAL PRESSURE ANALYZERS USED IN PROCESS MONITORING, U.S. Ser. No. 60/959,335; filed Jul. 13, 2007, the entire contents of which are herein incorporated by reference.

### FIELD OF THE INVENTION

This invention relates generally to ion sources for partial pressure analyzers used in process monitoring, and more particularly to in-situ cleaning methods of ion sources for partial pressure analyzers used in process monitoring.

### BACKGROUND OF THE INVENTION

In semiconductor manufacturing, the transition to larger, more expensive wafers and smaller geometries inevitably requires close production control. The more accurately and quickly one can measure and control a process, the more profitable their investment becomes. Therefore, more and more processes are requiring reliable in-situ monitoring and control. Partial pressure analyzers (PPA), sometimes known as residual gas analyzers (RGA), typically in the form of a quadrupole mass spectrometer, are widely used for in-situ process monitoring in semiconductor manufacturing, especially in physical vapor deposition (PVD) processes. Among the uses of the PPA for chemical vapor deposition (CVD)/etch processes are following the process chemistry by monitoring the timing and concentration of input gases; monitoring the reaction products; eliminating the waste; and assessing the “health” of the process chamber (by checking for leaks, residual contaminants, contaminants during processing and proper functioning of the tool). To-date, most applications of PPAs for CVD/etch process focused on process development, process optimization and troubleshooting. Relatively few PPAs are employed as in-situ CVD/etch process monitors for actual production owing to PPA lifetime issues often encountered with those applications. First, CVD/etch chemicals are typically highly reactive or corrosive. Second, deposits can form in the ion source, making insulating surfaces conductive or conductive surfaces insulating, resulting in sensor malfunction. This is especially true on surfaces which receive energetic electron or ion bombardment. Third, the ion source is heated by the filament, sometimes resulting in significant pyrolysis of CVD precursors or etching by-products.

Typically, PPAs for CVD/etch applications employ a closed ion source (CIS), rather than the open ion source of a true RGA. Using a CIS minimizes exposure of sensor components and its vacuum chamber to the reactive or corrosive constituents present in these applications. Even so, the resulting lifetime for a PPA in CVD/etch is often still not sufficient for in-situ monitoring on a production line. Applicant has developed an ion source, having a replaceable liner described in U.S. Pat. No. 7,041,984, extending the time before the source itself needs to be replaced. However, it is still necessary to break vacuum of the PPA system in order to replace the liner, negatively impacting tool availability. Even more important, however, is that replacing only the anode liner may not solve the problem completely. Sensitivity decrease may also be caused by deposits on other parts of the ion source besides the anode cylinder, such as the focus lens plate and total pressure collector plate.

When reactive substances are sampled, an insulating film can be deposited on the inner surfaces of the ion source. When bombarded by charged particles, these deposits can charge up, effectively altering the bias voltages applied to these electrodes, thus affecting their function, typically resulting in a loss of sensitivity for the instrument. In some processes, conductive rather than insulating deposits can form. If these deposits form on critical insulator surfaces, sensor performances can be adversely affected by causing leakage currents to flow.

The sensitivity loss problem can be especially troublesome when the PPA is used to monitor a dielectric deposition process such as silicon tetranitride (Si₃N₄) CVD, when silicon nitride and/or oxides are easily deposited. Silicon etch processes that produce silicon tetrachloride (SiCI₄) among other by-products result in the deposition of SiO₂ films whenever sufficient moisture is present, as is often the case. With both of these processes, an insulating coating on the inside of the anode cylinder has been detected, especially opposite the electron entrance, resulting in severe sensitivity loss. Being an insulator, the deposited material will pick up a negative charge under electron bombardment, effectively decreasing the positive potential applied to the anode. The quadrupole mass filter is biased approximately six volts less positive than the anode. This difference in bias determines the kinetic energy of the ions as they travel through the quadrupole mass filter. As the negative charge on the anode builds up, eventually things will reach a point where the ions no longer have sufficient ion energy to transit through the quadrupole mass filter, resulting in a severe drop in sensitivity. A similar mechanism, this time involving positive ion bombardment, will occur on the focus and total pressure collector plates, although at a slower rate reflecting the much smaller currents involved. While this will not cause a decrease in the kinetic energy of the ions in the mass filter, it can sufficiently defocus the ion beam, therefore also resulting in a loss in sensitivity.

Plasma cleaning processes have long been used not only for in-situ cleaning of semiconductor production tools, but also in the manufacture of automotive bumpers, stainless steel syringe needles, angioplasty balloon catheters, plastic lenses, golf balls, and lawnmower distributor covers, to name just a few. Such cleaning processes involve the removal of impurities and contaminants from surfaces through the use of plasma created from gaseous species by applying a strong electric field. The excited gas forms energetic ions, electrons, atoms, free radicals and other reactive species. Contaminants on the metal, ceramic, glass, or wafer surfaces are desorbed as a result of energetic particle bombardment. Additionally, there will be some surface heating associated with these impacts. There are multiple effects from the plasma including removing organic contamination, removing substrate material by ablation (micro-etching), increasing surface area, removing a weak boundary layer, cross-linking or branching to strengthen surface cohesion, and modifying surface chemistry to improve chemical and physical interactions at the bonding interface. No volatile solvents are required for plasma cleaning, thus eliminating waste and residue.

U.S. Pat. No. 7,005,634 describes a mass spectrometer with the capability of in-situ plasma cleaning of the ion source. The ion source was based on a thermionic metal ion emitter, which subsequently ionizes the sample by metal ion attachment, rather then employing electron impact ionization. Various schemes for producing the plasma were presented in the patent disclosure. This plasma cleaning process was repeatedly performed subsequent to the mass spectrometry utilizing a suitable delay after the ionization process. However, because its ionization apparatus is based on the mechanism of ionizing gases by the attachment of metal ion emitter, it is not applicable to the electron impact ion source currently under discussion.

### SUMMARY OF THE INVENTION

In brief, the in-situ cleaning method for partial pressure analyzers is based on inducing a hollow cathode discharge (HCD) inside the ion source. The HCD is formed by applying a high negative voltage to one or more parts of the ion source, including the anode electrode, the lens focus plate, and/or additional lens(es) plate(s).

According to one version, an ion source (CIS) apparatus with in-situ cleaning mode is provided, the ion source apparatus being attachable to a partial pressure analyzer (PPA). According to this version, the ion source apparatus comprises one or more inner surfaces, an anode electrode, a means of applying a high negative voltage to the anode electrode, and a means for electron emission. The in-situ cleaning mode provides for removal of contaminating deposits from the inner surfaces, by introducing into the ion source, a plasma producing gas producing positive ions, and applying the high negative voltage to the anode electrode, such that a hollow cathode discharge occurs within the anode electrode causing said positive ions to bombard one or more inner surfaces of the ion source and remove contaminating deposits.

The ion source apparatus further includes a focus lens plate and at least one additional lens(es) plate, wherein the high negative voltage is applied to one or more of the anode electrode, focus lens plate, and the at least one additional plate. In one preferred version, the at least one additional lens plate is a total pressure collector plate as found in a closed ion source (CIS) that is attachable to a partial pressure analyzer (PPA). However, the implementation of the hollow cathode discharge can be similarly applied to other electron impact ion sources, open or closed, which are defined minimally by a filament, anode and at least one lens (plate). Alternatively, non-electron impact ion sources can also apply the teachings described herein.

According to another version, there is provided a method of removal of contaminating deposits from an ion source, said ion source being attachable to a partial pressure analyzer (PPA), said ion source comprising an anode electrode, and a means for electron emission, said ion source having one or more inner surfaces, said method comprising one or more plasma cleaning cycles. According to the method, each of said plasma cleaning cycles comprises the steps of introducing a plasma producing gas into said ion source, said plasma producing gas producing positive ions, applying a high negative voltage to the anode electrode, so that a hollow cathode discharge occurs within said anode electrode causing said positive ions to bombard said one or more inner surfaces of said ion source and remove said contaminating deposits, removing said contaminating deposits from the ion source; and conditionally, upon satisfying a first condition, terminating the method.

In one preferred version, the ion source is a closed ion source that further includes a focus lens plate and a total pressure collector plate and wherein the high negative voltage is applied to one or more of the anode electrode, the focus lens plate, and the total pressure collector plate.

Alternatively, the ion source further comprises a focus lens plate and at least one additional plate, wherein the high negative voltage is applied to one or more of the anode electrode, the focus lens plate, and the at least one additional plate; and wherein a greater negative potential is applied to the focus lens plate and the at least one additional plate than is applied to the anode electrode, such that positive ions mainly bombard the focus lens plate and the at least one additional plate rather than the anode electrode. In this version, the at least one additional plate can be a total pressure collector plate.

According to one exemplary version, the high negative voltage is within the range of approximately −800 to −900V wherein the high negative voltage is one of direct current, current pulses, and/or radio frequency current.

The plasma producing gas according to described versions is one of argon, oxygen, hydrogen, and any combination thereof, though it will be readily apparent that other gases can be utilized. In one version, for example, the plasma producing gas is at least one of: nitrogen fluoride NF₃, chlorine fluoride CIF₃, carbon tetrafluoride CF₄, and hexafluoroethane C₂F₆. In another version, the plasma producing gas is at least one of nitrogen fluoride NF₃, chlorine fluoride CIF₃, carbon tetrafluoride CF₄, and hexafluoroethane C₂F₆, further combined with one of: argon, oxygen, and hydrogen.

With regard to the timing of the herein described method, the method can be performed at pre-determined intervals of process monitoring, when performance of the ion source has decreased by a pre-determined threshold value, or as an automated, in-situ process while said the ion source is otherwise idle.

In one version, the above-noted first condition is satisfied upon elapsing a pre-determined period of time. Alternatively, this condition is satisfied when a pre-determined value of the ion current measured by the PPA is reached.

These and other features and advantages will become readily apparent from the following Detailed Description, which should be read in conjunction with the accompanying drawings.

### BRIEF DESCRIPTION OF THE DRAWINGS

FIG. 1 illustrates a cross-sectional view of an exemplary ion source;

FIG. 2 illustrates a cross sectional view of an ion source in accordance with one embodiment of the present invention;

FIG. 3 illustrates a cross sectional view of an ion source in accordance with another embodiment of the present invention;

FIG. 4 is an experimental data graph showing mass spectra before and after plasma cleaning preformed in accordance with embodiments of the present invention, obtained with an ion source used to monitor a silicon tetranitride (Si₃N₄) CVD process; and

FIG. 5 is experimental data graph showing the spectra taken before and after each of six successive plasma cleans with argon at 1.0E-4 torr for an ion source used in tungsten CVD process, in accordance with embodiments of the present invention.

### DETAILED DESCRIPTION

The in-situ cleaning method for partial pressure analyzers described herein is based on inducing a hollow cathode discharge (HCD) inside an ion source. The HCD is formed by applying a high negative voltage to one or more parts of the ion source, including the anode electrode, a lens focus plate, and other len(ses) plate, such as a total pressure collector plate.

For purposes of the following discussion, an exemplary form of ion source, a closed ion source (CIS) is herein referred to throughout the bulk of the discussion. It will be readily apparent, however as noted above, that the inventive concepts can equally be applied to other electron impact ion sources, such as open ion sources that are used in residual gas analyzers (RGAs). Furthermore, the present concepts can also be employed to cover non-electron impact ion sources, for example, such as those described in U.S. Pat. No. 7,005,634.

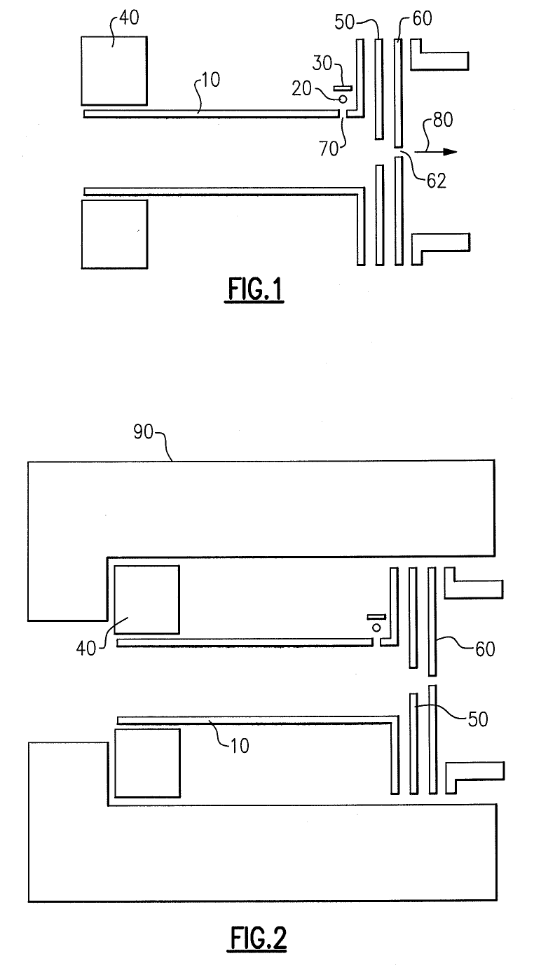

FIG. 1 illustrates a cross sectional view of a CIS manufactured and sold by Inficon, Inc. of East Syracuse, N.Y. An alumina insulator disc 40 provides a seal between the anode electrode 10 having a cylindrical form, and the flange holding the PPA gas inlet orifice (not shown in FIG. 1). There are also several ceramic sealing washers located between the plate to which the anode electrode 10 is affixed (not shown in FIG. 1), the focus lens plate 50, and the total pressure collector plate 60. The sampled gas can only exit the CIS through the slot 70 in the anode wall 10 through which the electrons enter into the cylindrical anode electrode 10, and through the hole 62 in the total pressure collector plate 60, through which the ions exit.

Electron emission means is provided by the filament 20 using a tungsten wire typically biased negatively with respect to the anode 10 during normal operation. It is heated by the current that passes through it. The emitted electrons are repelled by the electron repeller 30 and attracted by the anode electrode 10. The majority of the electrons pass through the slot 70 in the circumference of the anode. A fraction of the electrons collide with sample gas molecules inside the cylindrical anode electrode 10 and produce positive ions. The difference between the bias voltages on the filament 20 and the anode 10 determine the kinetic energy of the electrons. It is this kinetic energy that determines how the gas molecules will behave during the collision. The remaining electrons collide with the inside wall of the cylindrical anode electrode 10. The positive ions are attracted by the focus lens plate 50 (biased negative with respect to the anode 10) and are focused through the hole 62 in the total pressure collector plate 60 (also biased negative with respect to the anode 10) in the direction generally shown by the arrow 80 into the quadrupole mass filter (not shown in FIG. 1). A fraction of the ions produced strikes the total pressure collector plate 60. The magnitude of this current is proportional to the total pressure inside the anode 10.

A HCD can be formed within a CIS of the described configuration when a high negative potential is applied to one or more parts of the CIS, e.g., to the anode electrode, to the lens focus plate, and/or to the total pressure collector plate. The sputtering action of the HCD removes the insulating deposits from the inside of the cylindrical anode electrode and the surfaces of the focus and total pressure collector plates facing the anode, therefore restoring ion source performance and hence its lifetime before it must be replaced.

The plasma cleaning process of the present invention can be performed at pre-determined intervals of process monitoring or when the CIS performance has decreased by a pre-determined threshold value. While plasma cleaning can be performed on a CIS removed from the PPA, it can best be utilized as an automated, in-situ process while the PPA is otherwise idle.

FIG. 2 illustrates a CIS cross sectional view in accordance with one embodiment of the present invention. A high voltage (negative direct current (DC) of around −900 V, negative pulses, or radio frequency (RF) current) is applied to the anode 10 using a voltage source and a wiring and connecting means (not shown in FIG. 2). The flange 90 holding the PPA gas inlet orifice (not shown in FIG. 2) to which the CIS is sealed by the alumina insulating disc 40 serves as the positive ground electrode. The focus lens plate 50 and the total pressure collector plate 60 are floating. The HCD is concentrated within the anode electrode 10. Plasma producing gas (e.g., argon (Ar)) is introduced into the CIS. Positive ions produced by the plasma producing gas bombard the surface of the anode 10 and remove the contaminating deposits.

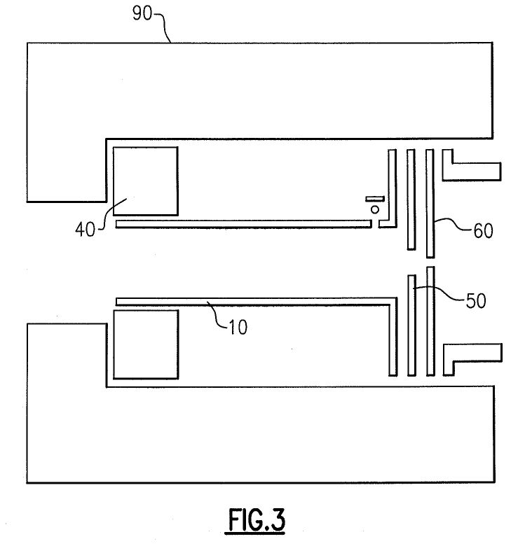

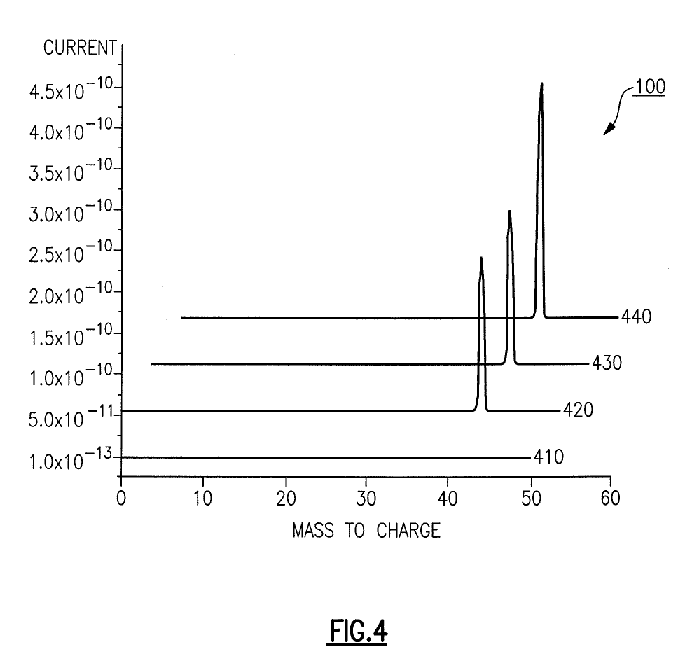

FIG. 3 illustrates a CIS cross sectional view in accordance with another embodiment of the present invention, wherein the high voltage bias is applied to the focus lens plate 50 and the total pressure plate 60 in addition to the anode electrode 10, using a voltage source and a wiring and connecting means (not shown in FIG. 3).

The embodiment illustrated in FIG. 3 is more suitable for applications involving metal-organic CVD (such as used to deposit tungsten (W)) and dielectric etch processes using certain fluorocarbon gases, where insulating films are not restricted to the anode but also form on the focus and total pressure collector plates. An insulating film can be formed of reaction by-products or of side reactions. In the case of tungsten CVD, the deposits consist of various oxides and suboxides of tungsten (WOₓ). For those etch applications using fluorocarbons, deposits of the general formula (CF₂)ₓ can be formed. While possessing the same empirical formula as Teflon, these films tend to be far more brittle, and might be formed as a result of “condensation” of CF₂ radicals (common in etching plasmas) on the surface. Neither of these examples requires bombardment of the surface by energetic species in order to form the deposit. As a result, these deposits tend to form on all surfaces of the CIS, including the focus and total pressure collector plates. They cause sensitivity loss by the same mechanisms described supra.

In accordance with the embodiment illustrated in FIG. 3, the HCD will fill the entire ion source internal volume, resulting in ion bombardment of all three surfaces, i.e., the internal walls of the cylindrical anode electrode 10, the focus lens plate 50, and the total pressure collector plate 60, thus removing the insulating deposits. By applying a greater negative potential to the focus lens plate 50 and the total pressure collector plate 60 than is applied to the anode 10, it is possible to concentrate the plasma action in the lens area rather than in the anode area, so that positive ions bombard mostly the focus lens plate and the total pressure collector plate rather than the anode electrode.

A skilled artisan would understand that applying a high negative voltage to one or more of anode electrode, focus lens plate, total pressure plate, or any combination thereof will be within the scope and the spirit of the present invention.

In on aspect, stable plasma can be obtained e.g., with argon (Ar) gas pressure in the range of 50 millitorr to 1 Torr (e.g., 100 millitorr). Using argon, deposit removal is accomplished only by sputter etching, a purely physical process.

In another aspect, other more reactive gases can be used either in addition to or in place of argon, depending on the nature of the process being monitored. Hydrocarbon deposits which can come, e.g., from vacuum pump lubricants, grease on o-rings, or photo-resist (PR) materials related to processes such as PR ashing and wafer degassing, can be removed using oxygen (O₂) in the plasma producing gas, thus forming volatile products, e.g., water (H₂O), carbon monoxide (CO), and carbon dioxide (CO₂) gases that can be easily pumped away from the ion source. Other process chemistries might best be handled using hydrogen (H₂) as the plasma producing gas. In severe contamination cases, typical semiconductor cleaning gases such as nitride trifluoride (NF₃) chlorine trifluoride (CIF₃), carbon tetrafluoride (CF₄ or hexafluoro ethane (C₂F₆), either alone or in combination with argon, oxygen or hydrogen, can be employed. In addition, there may also be gases not typically used for semiconductor cleaning processes that could be used.

In a further aspect, one or more plasma cleaning cycles can be carried out, each cycle including applying a high negative voltage to one or more parts of the CIS, including the anode electrode, the lens focus plate, and the total pressure collector plate, followed by removal (e.g., by pumping away) of the contaminants from the ion source.

In another aspect the cleaning process can be completed upon elapsing of a pre-determined period of time.

in yet another aspect, a spectrum can be taken by the PPA after each plasma cleaning cycle, and the cleaning process can be completed when a pre-determined value of the ion current is reached, e.g., Ar⁺ current equal to 2.8E-10 A. The noted ion current is not measured during the plasma cleaning phase because the pressure is too high. Instead, the plasma cleaning operation must first be stopped and the pressure of the argon is then lowered to about 1E-4 Torr before the filament is turned on and the current is measured.

FIG. 4 is an experimental data graph 100 showing mass spectra before and after plasma cleaning preformed in accordance with embodiments of the present invention, obtained with a CIS used to monitor a silicon tetranitride (Si₃N₄) CVD process. Each of the four spectra depicted was obtained at the argon (Ar) partial pressure of 1.0E-4 Torr inside the source. The first exemplary trace 410 was obtained before any plasma cleaning was attempted. The trace 410 shows no peaks associated with Ar. The second exemplary trace 420 was obtained after the first plasma clean with a negative anode bias between about −800 and −900 V, a discharge current of 25 μA and an Ar partial pressure of 100 millitorr. The focus and total pressure collector plates were left floating. The trace 420 shows an Ar⁺ peak at mass 40 with a current of 1.8E-10 A. The third trace 430 was obtained after a second plasma clean step under the same conditions as the first. The Ar⁺ current increased to 2.6E-10 A. A third and final plasma treatment was applied, this time with the total pressure collector plate connected to the same bias potential as the anode. The focus plate was left floating. The fourth trace 440 was then obtained. The Ar⁺ current increased very slightly to 2.8E-10 A. The fact that the third plasma clean resulted in only a very slight increase in sensitivity suggests that the insulating deposits that were the cause of the sensitivity loss were primarily confined to the cylindrical anode electrode. Insulating deposits on the total pressure collector plate were not sufficient to cause significant loss in sensitivity.

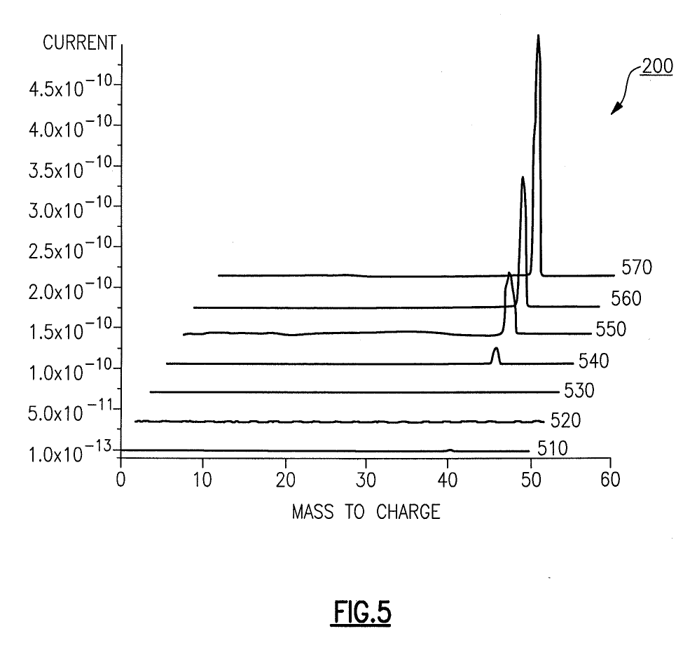

FIG. 5 is an experimental data graph 200 showing the spectra taken before and after each of six successive plasma cleanings with argon at 1.0E-4 torr for an ion source used in a tungsten CVD process, in accordance with embodiments of the present invention. Before plasma cleaning, only an extremely small Ar peak was observed at mass 40 indicating significantly degraded sensitivity after exposure to the process. Even after two plasma cleanings with 800 to 900V voltage applied to the anode only, at 100 mtorr argon pressure and 25 μA current, there was no significant change in the Ar⁺ peak intensity. For the remaining plasma clean steps, the total pressure collector plate and the anode both received the negative high voltage bias. After the third clean, the Ar⁺ current increased to 2.0E-11 A. After the fourth clean, the Ar⁺ current increased to 8.0E-11 A. After the fifth clean, the Ar⁺ current increased to 2.15E-10 A. Finally, after the sixth clean, the Ar⁺ current increased to a more normal current of 2.8E-10 A.

### PARTS LIST FOR FIGS. 1-5

10 anode electrode
20 filament
30 electron repeller
40 mass (insulating disc, aluminar)
50 focus lens plate
60 total pressure collector plate
62 hole
70 slot
80 arrow
90 flange

1. An ionization apparatus comprising:
a means for causing metal ions emitted from an ion emitter to attach to a target gas so as to produce ions of a sample gas;
a mechanism for emitting the ions of the sample gas to a mass spectrometer having a zone in which one or both of an electric field and magnetic field are formed;
an electrode for causing the generation of cleaning plasma provided in an ionization zone for generating the ions of the sample gas; and
wherein said plasma removes deposits on components facing said ionization zone.

2. An ionization apparatus as set forth in claim 1, wherein any of said components arranged inside said ionization zone is used as said electrode.

3. An ionization apparatus as set forth in claim 2, wherein said ion emitter is used as said electrode.

4. An ionization apparatus as set forth in claim 2, wherein an ion focusing electrode used in an ionization process is used as said electrode.

5. An ionization apparatus as set forth in claim 1, further providing an electrode especially for discharge in said ionization zone.

6. An ionization apparatus as set forth in claim 1, wherein when causing generation of plasma, a third-body gas used in an ionization process is sued as a discharge gas and substantially the same pressure condition as the pressure condition at said ionization process is used.

7. An ionization apparatus comprising:
a means for causing metal ions emitted from an ion emitter to attach to a target gas as to produce ions of a sample gas;
a mechanism for emitting the ions of the sample gas to a mass spectrometer having a zone in which one or both of an electric field and magnetic field are formed;
a hollow vessel formed to have an ionization zone in which ions of the sample gas are produced, and having a wall at the ionization zone side made by an electroconductive member;
an ion emission mechanism for emitting said metal ions;
a discharge gas introduction mechanism for introducing a discharge gas into said ionization zone;
an evacuation mechanism for discharging said discharge gas being introduced into said ionization zone outside of said hollow vessel; and
wherein the discharge gas being introduced into said ionization zone by said discharge gas introduction mechanism while said ionization zone is evacuated by said evacuation mechanism so as to maintain it at a predetermined pressure and one of said ion emission mechanism and said hollow vessel is used as a cathode and the other is used as an anode to cause the generation of plasma in said ionization zone so as to remove a deposit on the component used as the cathode facing said ionization zone.

8. An ionization apparatus as set forth in claim 7, wherein when removing the deposit on said ion emission mechanism facing said ionization zone, said ion emission mechanism is used as the cathode, while when removing the deposit on the inside walls of said hollow vessel facing said ionization zone, said inside wall of said hollow vessel is used as the cathode.

9. An ionization apparatus as set forth in claim 7, wherein the process of removing the deposit on a component facing said ionization zone by causing the generation of plasma in said ionization zone is performed consecutively after the process of causing said metal ions to attach to said target gas to generate said ions of the sample gas and emitting said ions of the sample gas to said mass spectrometer.

10. An ionization apparatus as set forth in claim 8, wherein when said target gas is gaseous state organic matter, after the ionization of said target gas, oxygen is introduced into the ionization zone and plasma is caused to be generated in said ionization zone while maintaining said predetermined pressure.

11. An ionization apparatus as set forth in claim 9, wherein when said target gas is a gaseous state metal compound or a compound including a semiconductor, after said target gas is ionized, a halogen-based gas is introduced into said ionization zone and the plasma is caused to be generated in said ionization zone while maintaining said predetermined pressure.

12. An ionization apparatus comprising:
a means for causing metal ions emitted from an ion emitter to attach to a target gas so as to produce ions of the sample gas;
a mechanism for emitting the ions of said sample gas to a mass spectrometer having a zone in which one or both of an electric field and magnetic field are formed;
a plasma generation chamber having a plasma generation zone communicated with said ionization zone where the ions of said sample gas are produced, and provided with a discharge gas introduction mechanism and plasma generation mechanism;
a plasma pull-in electrode arranged at said ionization zone;
an evacuation mechanism for evacuating said ionization zone and plasma generation zone; and
wherein said ionization zone and plasma generation zone being held at a predetermined pressure, said plasma generation zone being made to generate first plasma by said plasma generation mechanism, said first plasma being pulled into said ionization zone by the plasma pull-in electrode to cause the generation of second plasma, and thereby deposits on components facing said ionization zone being removed.

13. An ionization apparatus as set forth in claim 12, wherein said plasma generation mechanism uses a rod-shaped electrode.

14. An ionization apparatus as set forth in claim 12, wherein said plasma generation mechanism uses a spiral-shaped electroconductive member.

15. An ionization apparatus as set forth in claim 12, wherein said pull-in electrode serves also as an electrode contributing to transport of ions when emitting the ions of said sample gas to said mass spectrometer.
